(19) United States
(12) Patent Application Publication
(10) Pub. No.: US 2024/0081381 A1
(43) Pub. Date: Mar. 14, 2024

(54) Fluid Composition for Targeted Results

(71) Applicant: SEGGS Water LLC, Lutz, FL (US)

(72) Inventor: Mary Costello, Lutz, FL (US)

(73) Assignee: SEGGS Water LLC, Lutz, FL (US)

(21) Appl. No.: 18/458,634

(22) Filed: Aug. 30, 2023

Related U.S. Application Data
(60) Provisional application No. 63/405,468, filed on Sep. 11, 2022.

(51) Int. Cl. A23L 33/105; A23L 5/43; A23L 27/12; A23L 33/155; A23L 33/16

(52) U.S. Cl. CPC A23L 33/105; A23L 5/43; A23L 27/12; A23L 33/155; A23L 33/16

(57) ABSTRACT

A fluid composition includes water combined with at least five adaptogens (typically extract or powder) that include 0.5 mg to 3000 mg of maca root, 0.5 mg to 400 mg of tongkat ali, 0.5 mg to 500 mg of ashwaganda, Omg to 500 mg of shilajit, 0.5 mg to 500 mg of shatavari root, 0.5 mg to 1000 mg of horny goat weed leaf, 0.5 mg to 5000 mg of schisanda berry, 0.5 mg to 1500 mg of tribulus terrestris or yohimbine, 0.5 mg to 600 mg of fenugreek, 0.5 mg to 240 mg of Ginkgo biloba, 0.5 mg to 800 mg of Turnera difusa, 0.5 mg to 1050 mg of Muira puama, Omg to 1000 mg of L-arginine, between Omg to 40 mg of Chasteberry, and Omg to 160 mg of Lavender (oil or powder). In some embodiments, the fluid composition further comprises electrolytes, vitamins, carbohydrates for energy, flavoring, and/or carbonation.

### FIELD OF THE INVENTION

This invention relates to the field of beverages and more particularly to a fluid composition for human consumption that has positive health benefits.

### BACKGROUND OF THE INVENTION

Many food or drink substances are believed to impact the libido. For example, oysters have been considered as a natural food used to increase sex drive and desire. Red ginseng and Yohimbine has been reported to improve sex drive. Many foods, at one time or another, have been held highly as foods that improve sex drive and desire, including chocolate, artichokes, asparagus, spicy chili peppers, strawberries, watermelon, and figs.

Several adaptogens are also known and believed to impact the libido. It is believed that consuming certain amounts of such adaptogens improves sexual desire and/or performance.

Further, it is important to maintain overall health and vigor to perform well in bed. Certain vitamins, minerals, and carbohydrates help support male and/or female health during and after sex. Further, it is important to revitalize after sex, replacing hydration and electrolytes that are depleted during exercise.

What is needed is a fluid that will provide an array of adaptogens as well as other useful vitamins, minerals, and electrolytes.

### SUMMARY OF THE INVENTION

In one embodiment, a fluid composition is disclosed. The ingredients for producing 37 gallons of such fluid composition include 35.96 gallons of water combined with 1.886 pounds of Citric Acid, 3.29 pounds Cane Sugar, 0.666 pounds Malic Acid, 41.45 grams Magnesium Sulfate, 5.92 grams Zinc Gluconate, 0.19 gram Copper Gluconate, 0.1665 grams Vitamin B3 Niacinamide, 0.11 grams Vitamin A Palmitate, 8.621 grams Vitamin B12, 1.08 pounds Potassium Citrate, 0.9435 pounds Calcium Lactate, 17.62 grams Sea Salt, 19.3 grams purple plum coloring (e.g., Exberry® Shade Purple Plum), 0.65 pounds Maca Root, 59.41 grams Tongkat (e.g., Tongkat Ali), 74.68 grams Ashwagandha, 74.68 grams Shatavari, 59.41 grams Xian Ling Pi Dried Herb Glycerite, 0.65 pounds Schisandra Alcohol Free Extract, 30.21 grams Fenugreek Fruit Alcohol Free Extract, 18.46 grams Ginkgo Biloba Dried Leaf Glycerite, 15.10 grams Damiana Old Woman's Broom Dried Leaf Extract, 148.53 grams Muira Puama Glycerite and flavoring including 156.08 grams natural cherry type flavor, 117.48 natural sucrose enhancer, and 245.03 natural limeade flavor extract. This composition is produced in a tank suitable for holding at least 1000 gallons of liquid. First the water is added, then the citric acid and mixed for 5 to 10 minutes. Next the cane sugar and other dry ingredients are added and mixed until they are dispersed. Next all remaining ingredients are added in order while mixing. The solution is mixed or agitated for at least 30 minutes. Next the pH and Brix are tested, and the pH is adjusted to approximately 3.85 using citric acid if needed. The brix is adjusted by adding sugar to a reading of approximately 3.2 degrees. If delivered in cans, the cans are filled and optionally carbonated to the can manufacturer's specifications for tunnel pasteurization. Tunnel pasteurization is then performed as required, estimated to be 163 F for 15 minutes, then cooling the cans to less than 100 F as quickly as possible. In some embodiments, slightly more or less or each ingredient is added to the composition.

In another embodiment, a fluid composition is disclosed including 16 oz of water combined with at least five adaptogens. The adaptogens include between 0.5 mg and 3000 mg of maca root extract or powder, between 0.5 mg and 400 mg of tongkat ali extract or powder, between 0.5 mg and 500 mg of ashwaganda extract or powder, between 0 mg and 500 mg of shilajit extract or powder, between 0.5 mg and 500 mg of shatavari root extract or powder, between 0.5 mg and 1000 mg of horny goat weed leaf also known as epimedium extract or powder, between 0.5 mg and 5000 mg of schisanda berry extract or powder, between 0.5 mg and 1500 mg of tribulus terrestris also known as yohimbine extract or powder, between 0.5 mg and 600 mg of fenugreek extract or powder, between 0.5 mg and 240 mg of Ginkgo biloba extract or powder, between 0.5 mg and 800 mg of Turnera difusa extract or powder, between 0.5 mg and 1050 mg of Muira puama extract or powder, between 0 mg and 1 g of I-arginine extract or powder, between 0 mg and 40 mg of Chasteberry extract or powder, and between 0 mg and 160 mg of Lavender (oil or powder) extract or powder.

In some embodiments, the fluid composition further comprises electrolytes, vitamins, carbohydrates for energy, flavoring, and/or carbonation.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

The fluid composition for targeted results is made from a base liquid such as water (e.g., spring water, purified water, distilled water, water included in fruit juices) and fortified with several panels of substances. For the remainder of this specification, the ingredients are specified as weight per 16 oz (approximately 473 ml) of product. Generally, the ingredients from the combined panels have a total weight of approximately 450 g and mixed with the base liquid (e.g., water) to produce 16 oz of the fluid composition or product. Note that it is fully anticipated that production is scaled to higher production yields such as 55 gallons or higher.

Although other panels of ingredients are anticipated, four panels are described. The first is an adaptogen panel of ingredients that is related to libido enhancement. The second is an electrolyte panel of ingredients related to replacing or enhancing electrolytes, especially after intense physical activity. The third is a health panel related to vitamins and minerals that are important for maintaining the health of such active individuals. The fourth panel is an energy panel related to providing fast and slow release of energy in the body and, therefore, improving body performance during sex and other activities. There is also an optional taste panel that provides ingredients that give the fluid composition for targeted results a desired taste, consistency, and carbonation level.

The adaptogens panel of ingredients is related to libido enhancement and includes at least one adaptogen. In one embodiment, the adaptogens panel of ingredients includes at least seven adaptogens totaling at least three grams. In some embodiments, the adaptogens are organic powders or extracts. Any or all the following adaptogens are included in the specified weight range in the first panel of ingredients:
From 0.5 mg to 3000 mg of Maca root extract or powder
From 0.5 mg to 400 mg of Tongkat ali extract or powder
From 0.5 mg to 500 mg of Ashwaganda (Indian extract) extract or powder
From 0 mg to 500 mg of Shilajit extract or powder
From 0.5 mg to 500 mg of Shatavari root extract or powder
From 0.5 mg to 1000 mg of Horny goat weed leaf (epimedium) extract or powder
From 0.5 mg to 5000 mg of Schisanda berry extract or powder
From 0.5 mg to 1500 mg of Tribulus terrestris or yohimbine extract or powder
From 0.5 mg to 600 mg of Fenugreek extract or powder
From 0.5 mg to 240 mg of Ginkgo biloba extract or powder
From 0.5 mg to 800 mg of Turnera difusa extract or powder
From 0.5 mg to 1050 mg of Muira puama extract or powder
From 0 mg to 1 g of L-arginine extract or powder
From 0 mg to 40 mg of Chasteberry extract or powder
From 0 mg to 160 mg of Lavender (oil or powder) extract or powder

In one embodiment of the present invention, the adaptogen panel includes seven or more of the following adaptogens in the specified weight:
200 mg of Tongkat ali extract or powder
200 mg of Ashwaganda (Indian extract or powder) extract or powder
200 mg of Shatavari root extract or powder
200 mg of Horny goat weed leaf extract (epimedium) extract or powder
1 g of Schisandra extract or powder
100 mg of Fenugreek extract or powder
50 mg of Turnera (Damiana) extract or powder
500 mg of Muira puama extract or powder
500 g of Maca root extract or powder
60 mg of Ginkgo biloba extract or powder

The electrolyte panel of ingredients includes electrolyte substances that have a positive or negative electrical charge when dissolved in water and help your body to regulate chemical reactions and to maintain the balance between fluids inside and outside your cells. Often, during sex or other physical activities, a person sweats and the body loses electrolytes. Therefore, electrolytes are provided in the fluid composition to replenish the electrolytes lost during sex and other activities. In some embodiments, the electrolytes are from organic sources. The electrolyte panel of ingredients includes between 2.54 mg and 133.1 mg of electrolytes from the following group:
From 0.5 mg to 3 mg of Zinc
From 20 mg to 130 mg Magnesium
From 0.04 mg to 0.10 mg Copper

The electrolyte panel of ingredients also includes between 0.007 and 2 grams of electrolytes from the following group:
From 0.05 mg to 500 mg of Sodium
From 0.01 mg to 1000 mg Potassium
From 0.01 mg to 500 mg Calcium

In one embodiment, the electrolyte panel of ingredients includes the following electrolytes:
1 mg of Zinc
80 mg Magnesium
0.1 mg of Copper
150 mg of Sodium
720 mg of Potassium
197 mg of Calcium

The health panel of ingredients is related to maintaining health and, therefore, improving body performance during sex and other activities. The heath panel includes vitamins and minerals. In one embodiment, the health panel of ingredients includes from 0.001 mg to 6 g of vitamins and minerals including one or more of B vitamins (e.g., B3, B6, B5 and B12), vitamin E, vitamin D, vitamin A, and vitamin C. In another embodiment, the health panel of ingredients includes 0.001 to 4 mg of vitamins and minerals comprising vitamin B3, vitamin B6 and any other vitamins from the following list of vitamins: other B vitamins (e.g., B5 and B12), vitamin E, vitamin D, vitamin A, and vitamin C.

In one embodiment, the health panel of ingredients includes the following ingredients:
d-alpha tocopheryl acetate 700 IU/gm
Niacin (niacinamide)
Vitamin A (retinyl palmitate) 250000 IU
Vitamin D3 (cholecalciferol) 100000 IU
Maltodextrin (organic, tapioca)
Pantothenic acid (calcium-D pantothenate)
Vitamin B12 (cyanocobalamin, 0.1% on maltodextrin)
Vitamin B6 (pyridoxine hydrochloride)

These above ingredients provide the following embodiment of vitamins:
Vitamin A 0.018 mg
Vitamin B6 0.034 mg
Vitamin B12 0.000048 mg
Vitamin D 0.00040 mg
Vitamin E (U.S.) 0.30 mg
Pantothenic acid 0.10 mg
Niacin 0.32 mg

The energy panel of ingredients is related to maintaining providing fast and slow release of energy in the body and, therefore, improving body performance during sex and other activities. The energy panel includes sugars. In one embodiment, the energy panel of ingredients includes at least 15 grams sugar. In one embodiment, the sugars are 1 gram to 20 grams healthy sugars, such as cane sugar.

A taste panel optionally provides flavor and carbonation (e.g., using carbon dioxide). In one embodiment, the taste panel consists of a mildly carbonated, mild fruit flavor. In some embodiments, flavorings are added such as one or two fruit flavors. In some embodiments a flavor panel will include flavors that provide an energizing morning experience such as fruity or woodsy flavorings. In some embodiments the flavor panel will include flavors that provide a quick boost of energy and vitality having a spicy flavor (e.g., cayenne pepper flavor). In one embodiment, the flavor panel provides for black cherry limeade flavor with carbonation.

In some embodiments, the fluid composition for targeted results is further targeted to the male body or to the female body, as each has specific biological needs. In some embodiments, both the fluid composition for targeted results for males and fluid composition for targeted results for females include an electrolyte panel, health panel, energy panel, and taste panel from above, but will differ by way of the adaptogen panel.

In the fluid composition for targeted results for males, any or all of the following adaptogens are included in the specified weight range:
From 0.5 mg to 3000 mg of Maca root extract or powder
From 0.5 mg to 400 mg of Tongkat ali extract or powder
From 0.5 mg to 500 mg of Ashwaganda (Indian extract or powder) extract or powder
From 0.5 mg to 500 mg of Shatavari root extract or powder
From 0.5 mg to 1000 mg of Horny goat weed leaf extract or powder (epimedium)
From 0.5 mg to 5000 mg of Schisanda berry powder extract or powder
From 0.5 mg to 1500 mg of Tribulus yohimbine extract or powder
From 0.5 mg to 600 mg of Fenugreek extract or powder
From 0.5 mg to 240 mg of Ginkgo biloba extract or powder
From 0.5 mg to 1000 mg of L-arginine extract or powder

In the fluid composition for targeted results for females, any or all of the following adaptogens are included in the specified weight range:
From 0.5 mg to 160 mg of Lavender (e.g., powder or extract) extract or powder
From 0.5 mg to 40 mg of Chasteberry extract or powder
From 0.5 mg to 1500 mg of Tribulus yohimbine extract or powder
From 0.5 mg to 600 mg of Fenugreek extract or powder
From 0.5 mg to 3000 mg of Maca root extract or powder
From 0.5 mg to 400 mg of Tongkat ali extract or powder
From 0.5 mg to 500 mg of Ashwaganda (Indian extract or powder) extract or powder
From 0.5 mg to 500 mg of Shatavari root extract or powder
From 0.5 mg to 1000 mg of Horny goat weed leaf (epimedium) extract or powder
From 0.5 mg to 5000 mg of Schisanda berry extract or powder

In one embodiment of the fluid composition for targeted results for females, the following adaptogens are included in the specified weight range:
From 0.5 to 40 mg of Lavender (e.g., powder or extract) extract or powder
From 0.5 to 20 mg of Chasteberry extract or powder
From 0.5 mg to 1500 mg of Tribulus yohimbine extract or powder
From 0.5 mg to 600 mg of Fenugreek extract or powder
From 0.5 mg to 3000 mg of Maca root extract or powder
From 0.5 mg to 400 mg of Tongkat ali extract or powder
From 0.5 mg to 500 mg of Ashwaganda (Indian extract or powder) extract or powder
From 0.5 mg to 500 mg of Shatavari root extract or powder
From 0.5 mg to 1000 mg of Horny goat weed leaf (epimedium) extract or powder
From 0.5 mg to 5000 mg of Schisanda berry extract or powder

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A fluid composition comprising:
16 oz of water combined with at least five adaptogens selected from the group consisting of:
between 0.5 mg and 3000 mg of maca root extract or powder,
between 0.5 mg and 400 mg of tongkat ali extract or powder,
between 0.5 mg and 500 mg of ashwaganda extract or powder,
between 0 mg and 500 mg of shilajit extract or powder,
between 0.5 mg and 500 mg of shatavari root extract or powder,
between 0.5 mg and 1000 mg of horny goat weed leaf extract or powder,
between 0.5 mg and 5000 mg of schisanda berry extract or powder,
between 0.5 mg and 1500 mg of tribulus terrestris or yohimbine extract or powder,
between 0.5 mg and 600 mg of fenugreek extract or powder,
between 0.5 mg and 240 mg of Ginkgo biloba extract or powder,
between 0.5 mg and 800 mg of Turnera difusa extract or powder,
between 0.5 mg and 1050 mg of Muira puama extract or powder,
between 0 mg and 1000 mg of L-arginine extract or powder
between 0 mg and 40 mg of Chasteberry extract or powder, and
between 0 mg and 160 mg of Lavender (oil or powder) extract or powder.

2. The fluid composition of claim 1, further comprising:
between 2.54 mg and 133.1 mg of electrolytes comprising:
between 0.5 mg and 3 mg of Zinc;
between 20 mg and 130 mg Magnesium; and
between 0.04 mg and 0.10 mg Copper.

3. A fluid composition comprising:
36 gallons of water combined with:
1.886 pounds of citric acid;
3.29 pounds cane sugar;
0.666 pounds malic acid;
41.45 grams magnesium sulfate;
5.92 grams zinc gluconate;
0.19 gram copper gluconate;
0.1665 grams Vitamin B3 Niacinamide;
0.11 grams vitamin A palmitate;
8.621 grams vitamin B12;
1.08 pounds potassium citrate;
0.9435 pounds calcium lactate;
17.62 grams sea salt;
19.3 grams of coloring;
0.65 pounds maca root;
59.41 grams tongkat;
74.68 grams ashwagandha;
74.68 grams shatavari;
59.41 grams xian ling Pi dried herb glycerite;
0.65 pounds schisandra alcohol free extract;
30.21 grams fenugreek fruit alcohol free extract;
18.46 grams Ginkgo biloba dried leaf glycerite;
15.10 grams damiana old woman's broom dried leaf extract;
148.53 grams muira puama glycerite; and
Up to 600 grams of flavoring.

4. The fluid composition of claim 3, wherein the flavoring comprises:
156.08 grams natural cherry type flavor;
117.48 grams natural sucrose enhancer; and
245.03 grams natural limeade flavor extract.

5. The fluid composition of claim 3, wherein the coloring comprises 19.3 g purple plum coloring.

6. A fluid composition comprising:
36 gallons of water combined with:
1.8 pounds of citric acid;
3.3 pounds cane sugar;
0.65 pounds malic acid;
41.5 grams magnesium sulfate;
5.9 grams zinc gluconate;
0.18 gram copper gluconate;
0.17 grams vitamin B3 niacinamide;
0.11 grams vitamin A palmitate;
8.6 grams vitamin B12;
1.1 pounds potassium citrate;
0.95 pounds calcium lactate;
17.6 grams sea salt;
Between 19 grams and 20 grams coloring;
0.65 pounds maca root;
59.4 grams tongkat;
74.7 grams ashwagandha;
74.7 grams shatavari;
59.4 grams xian ling pi dried herb glycerite;
0.65 pounds schisandra alcohol free extract;
30.2 grams fenugreek fruit alcohol free extract;
18.5 grams Ginkgo biloba dried leaf glycerite;
15.10 grams damiana old woman's broom dried leaf extract;
148.5 grams muira puama glycerite; and
up to 600 grams of flavoring.

7. The fluid composition of claim 6, wherein the flavoring comprises:
156 grams natural cherry type flavor;
117 grams natural sucrose enhancer; and
245 grams natural limeade flavor extract.

8. The fluid composition of claim 6, wherein the coloring comprises 19-20 grams of purple plum coloring.
